(19) United States
(12) Patent Application Publication
(10) Pub. No.: US 2006/0221593 A1
(43) Pub. Date: Oct. 5, 2006

(54) Integrated illumination for marketing process and apparatus

(76) Inventor: Ray M. Alden, Raleigh, NC (US)

Correspondence Address: Ray M. Alden, 808 Lake Brandon Trail, Raleigh, NC, 27610, US

(21) Appl. No.: 11/095,403

(22) Filed: Mar. 31, 2005

(51) Int. Cl. F21K 2/00; H01J 1/62; H01J 63/04

(52) U.S. Cl. 362/34; 313/504

(57) ABSTRACT

The invention described herein represents a significant improvement in the ability to communicate marketing messages to consumers as an integrated system with illumination. Generally the marketing message comprises two coordinated aspects including sound such as a voice or jingle and a combination of lights including either a Logo image, a series of multi color flashes, or a series of white light flashes. The marketing message may also incorporate the aspect of smell integrated with the bulb. After the marketing message has been communicated, the bulb, fixture, lamp, or appliance performs a white light illumination function. The lighting bulbs, fixtures, lamps, appliances, and methods can be manufactured very reliably and cheaply and provide novel unobvious opportunities to communicate messages to consumers.

### BACKGROUND FIELD OF INVENTION

Modern lighting fixtures are produced in many shapes and designs but each shares the basic common function of making people more efficient and improving life by providing illumination to enable the human eye to better observe a real world environment. Over the past 100 years, lights have been used in many applications and integrated with many additional elements to perform many functions and offer additional advantages. Flash lights have been integrated with radios for example to offer consumers two functions in one portable appliance. Illuminators such as lamps for inside the home and lamps for outside the home have been manufactured to incorporate additional means to cause them to be turned “on” and “off” using non-contact stimulus such as the clapper that responds to a sound or a motion detector that senses motion. Aromatic products have been made that are designed to be deposited by a consumer onto the surface of a light bulb which when heated during use causes the deposition to emit a desired aromatic scent. Each of the preceding having been incorporated with a basic illuminating light. The present invention provides a sequence of sounds, music, lights, colors, images, and/or scents integrated with a light bulb or light fixture which produces white light and also responds to stimulus and creates a unique product marketing and brand awareness opportunity.

### BACKGROUND-DESCRIPTION OF PRIOR INVENTION

LED lights are known that comprise multiple semiconductors each respectively producing different colored light. An example of such LEDs integrated into a light bulb can be seen at www.ccrane.com, a retailer of fine merchandise, which lists one such LED light bulb called the “Color Changing Light Bulb” that changes color continuously when it is on. The present invention comprises a bulb that likewise changes color but does so when it is first turned “on” and in conjunction to a marketing melody but then reverts to a white light for illumination. The present invention enabling a company to put their marketing logo (or alternately a sequence of color flashes) together with a concurrent marketing jingle thus enabling a company to establish and build its brand name with a consumer while also providing the standard illumination function.

Flash lights have been integrated with radios that enable a user to carry one appliance that covers two basic consumer needs including directional illumination and the radio enabling awareness of local events. Also, clock radios have been made that comprise a casing made of translucent diffuse plastic and LEDs inside that enable the radio to change colors, www.sharperimage.com listing one such radio that changes colors every hour as a means to enhance the mood of a room. The present invention in one embodiment similarly incorporates a diffuse surface and LEDs “on” the inside. The present invention differs in that the LEDs blink in sequence in conjunction with a marketing jingle or display a Logo in conjunction with a marketing jingle and then transforms to a white light illuming lamp integrated within the radio function.

Also, prior art has been manufactured to be turned “on” and “off” using non-contact stimulus such as the clapper and a motion sensor. Clappers and motion triggered lamps are well known where sound or infrared radiation are sensed and used to trigger a lighting fixture which then performs the illumination function. This present invention differs form this prior art in that it uses a sound or motion sensor to trigger a marketing message comprising a series of light flashes in conjunction with a marketing jingle or a logo in conjunction with a marketing jingle and then provides white light for the illumination function.

Aromatic products have been made that are designed to be sprayed into the air or deposited by a consumer onto the surface of a light bulb which when heated during use causes the deposition to emit a desired aromatic scent. The present invention provides for a manufacturing and packaging process to produce aromatic bulbs that enable a consumer to freshen air for the life of the bulb without the consumer needing to deposit freshener periodically or interact in any way and while the light bulb performs its main function of illumination.

The incandescent light bulb itself has remained nearly unchanged for decades and continues to fulfill the very significant function of illumination for hundreds of millions of consumers. The present invention integrates marketing functionality into the standard incandescent bulb in the form of a cheap jingle enunciator that is initiated when the bulb is turned “on” but does not interfere with the illumination mission of the bulb. Since the light bulb with integrated enunciator is so cheap, companies can have their jingles and marketing message integrated therein and give the bulbs away to consumers for free to build brand awareness among consumers.

### BRIEF SUMMARY

The invention described herein represents a significant improvement in the ability to communicate marketing messages to consumers as an integrated system with illumination. Generally the marketing message comprises two coordinated aspects including sound such as a voice or jingle and a combination of lights including either a Logo image, a series of multi color flashes, or a series of white light flashes. The marketing message may also incorporate the aspect of smell integrated with the bulb. After the marketing message has been communicated, the bulb, fixture, lamp, or appliance performs a white light illumination function. The lighting bulbs, fixtures, lamps, appliances, and methods can be manufactured very reliably and cheaply and provide novel unobvious opportunities to communicate messages to consumers.

### OBJECTS AND ADVANTAGES

Accordingly, several objects and advantages of the present invention are apparent. It is an object of the present invention to provide an inexpensive marketing communication channel into large consumer mass markets. It is an object of the present invention to provide an illumination device which enables a user to see their environment. It is an object of the present invention to provide an integrated device comprising at least two functions including a marketing communications function and an illumination function performed in series or concurrently.

It is an advantage of the present invention that a marketing sound such as a jingle or voice or other is triggered periodically as part of an inexpensive illuminator such as a bulb, fixture, lamp, or appliance. It is an advantage of the present invention that a marketing logo, sequence of lights, or sequence of colors is triggered periodically as part of an inexpensive illuminator such as a bulb, fixture, lamp, or appliance. It is an advantage of the present invention that an aromatic scent is integrated with an inexpensive illuminator such as a bulb, fixture, lamp, or appliance and can be coordinated with a marketing message. It is an advantage of the present invention that a marketing sound and visual and scent can be integrated together to comprise a marketing message integrated with an illuminator.

Further objects and advantages will become apparent from the enclosed figures and specifications.

### DRAWING FIGURES

FIG. 1 illustrates a preferred process of manufacturing and packaging a scented illumination bulb of the present invention.

FIG. 2 illustrates the elements and operation process of a light bulb and a light fixture in a lightning/thunder embodiment.

FIG. 3 illustrates the elements and operation process of a light bulb and a light fixture in an angelic embodiment.

FIG. 4 illustrates the elements and operation process of a light bulb and a light fixture in a clarity activated embodiment.

FIG. 5 illustrates the elements and operation process of a light bulb and a light fixture in a sneeze activated embodiment.

FIG. 6a illustrates the elements and operation process of a light bulb and a light fixture comprising an enunciator and an air freshener.

FIG. 6b illustrates the elements and operation process of a light bulb and a light fixture comprising an enunciator and an air fan.

FIG. 6c illustrates the elements and operation process of a lamp comprising an enunciator.

FIG. 7a illustrates the elements and operation process of a light fixture in a doughnut marketing jingle and smell embodiment.

FIG. 7b illustrates the elements and operation process of a light fixture in a radio talk show marketing jingle and smell embodiment.

FIG. 7c illustrates the elements and operation process of a light fixture in a dental office marketing jingle and smell embodiment.

FIG. 7d illustrates the elements and operation process of a light fixture in a motion picture marketing jingle and smell embodiment.

FIG. 7e illustrates the elements and operation process of a light fixture in a sporting event marketing jingle and smell embodiment.

FIG. 8a illustrates the elements and operation process of an LED marketing/illumination light bulb with diffuser.

FIG. 8b illustrates the elements and operation process of an LED marketing/illumination light bulb with jingle and color flash pattern.

FIG. 8c illustrates the elements and operation process of an LED marketing/illumination light bulb with jingle and logo projection pattern.

FIG. 9a illustrates the elements and operation process of an LED marketing/illumination light bulb projecting a logo projection pattern onto a wall.

FIG. 9b illustrates the elements and operation process of an LED marketing/illumination light bulb projecting a logo projection pattern onto a translucent diffuse surface.

FIG. 10a illustrates the elements and operation process of a cylindrical OLED marketing/illumination light bulb.

FIG. 10b illustrates the elements and operation process of an OLED marketing/illumination light bulb of FIG. 10a rolled into an OLED illumination desk top bulb.

FIG. 10c illustrates the elements and operation process of an OLED marketing/illumination light bulb of FIG. 10a rolled into an OLED illumination screw in bulb.

FIG. 10d illustrates the elements and operation process of an OLED marketing/illumination light bulb of FIG. 10a rolled into an OLED illumination 3D bulb with rotating lenticular array.

FIG. 11a illustrates the elements and operation process of a conic section OLED marketing/illumination light bulb.

FIG. 11b illustrates the elements and operation process of a conic section OLED marketing/illumination light bulb and support form.

FIG. 11c illustrates the elements and operation process of an assembled conic section OLED marketing/illumination light bulb and support form

FIG. 12a illustrates the elements and operation process of a radio with integral illumination lamp and LED marketing communications system in the logo mode.

FIG. 12b illustrates the elements and operation process of a radio with integral illumination lamp of FIG. 12a in the illumination mode.

FIG. 12c illustrates the elements and operation process of a radio with integral illumination lamp of FIG. 12a in the radio display mode.

FIG. 13a illustrates the OLED element integrated into a radio with to perform integral illumination lamp and LED marketing communications.

FIG. 13b illustrates the elements and operation process of a radio with integral illumination lamp and LED marketing communications system in the marketing flash sequence mode.

FIG. 13c illustrates the elements and operation process of a radio with integral illumination lamp and LED marketing communications system in the illumination mode.

FIG. 14a illustrates an enunciator circuit suitable for integration with illumination products and emitting marketing jingles when activated.

FIG. 14b illustrates an enunciator circuit suitable for integration with illumination products and emitting marketing jingles and integration with timers and activating mechanisms.

FIG. 15a illustrates a timer circuit suitable for activating marketing jingle and concurrent coordinated lighting sequences.

FIG. 15a illustrates a sound sensor circuit suitable for activating marketing jingle and concurrent coordinated lighting sequences.

### DETAILED DESCRIPTION OF THE INVENTION

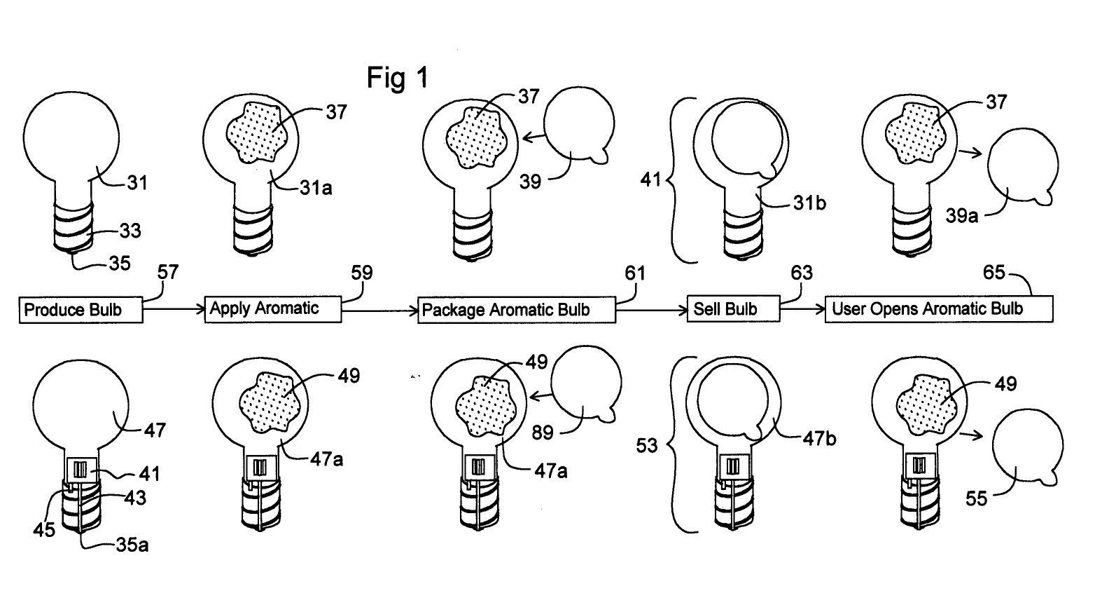

FIG. 1 illustrates a preferred process of manufacturing and packaging a scented illumination bulb of the present invention. In a bulb production step 57, a standard light bulb 31 is manufactured including a first electrical contact 33 and a second electrical contact 35 according to standard production methods well know in the industry. In an aromatic application step 59, an aromatic material 37 is applied to the surface of the bulb with aromatic deposition 31a. The deposition process can be one of spraying or dipping the light bulb and the aromatic material can be one as is described in US Published Patent Application 20020147053 Chrisman or can be a substance commonly used in plug-in air fresheners widely available. Moreover, the surface of the bulb may be manufactured from a material such as that described in 20020147053 with fragrance incorporated therein. In a packaging step 61, the aromatic material is substantially covered by a wax paper type cover 39 which is caused to adhere to either 31a or 37 to prevent the 37 from being scratched, rubbed off; removed, exposed to light, exposed to moisture, exposed to air, or otherwise interacting with the environment prematurely. Alternately, Styrofoam could be used as packaging to prevent the bulb from being exposed to heat. As an alternate to the 39 type cover, the 31a and the 37 thereon can be deposited and sealed into a bag or shrink-wrap envelope to protect it. In a sell bulb step 63, the bulb is purchased as a unit including the packaging which prevents the aromatic material from interacting with the environment. In a user opening step 65, a user removes the packaging from the bulb exposing the 37 to interact with the environment such as by removing the removed cover 39a. Thus a process of making and using an aromatic light bulb comprises a bulb manufacturing step, an aromatic application step, a packaging step, a transportation/distribution step, and an un-packaging step.

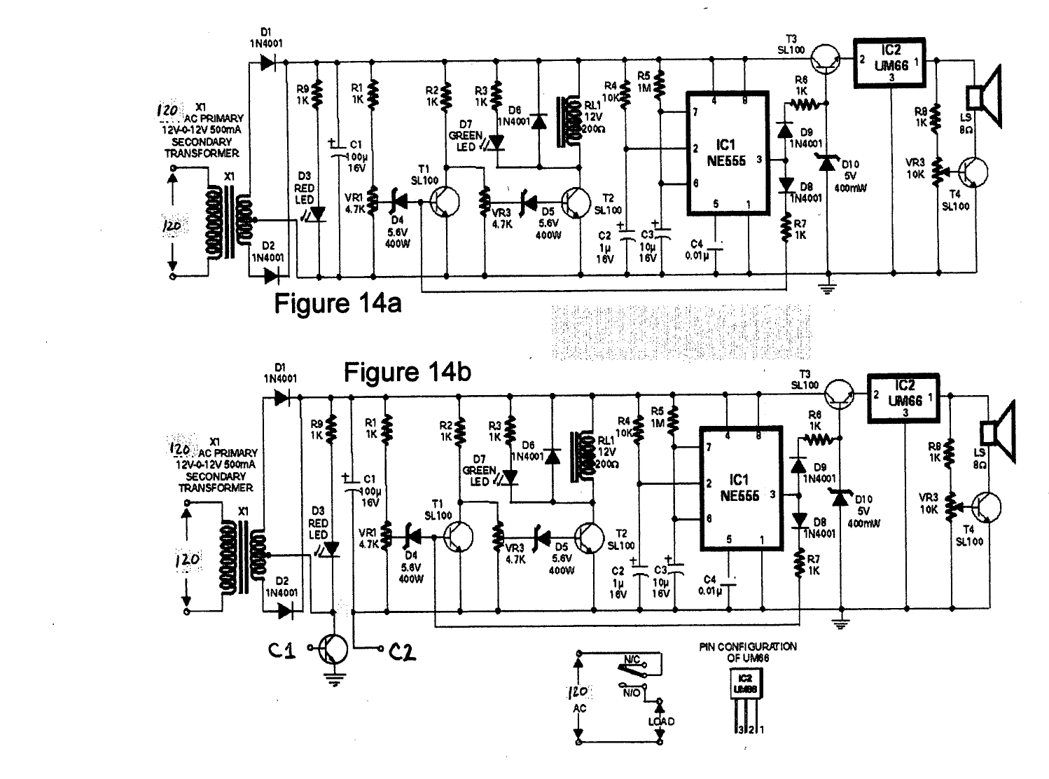

A bulb with integrated enunciator 47 is manufactured similarly to the standard light bulb except that an enunciator 41 comprising a circuit such at that disclosed in FIG. 14a or FIG. 14b is affixed to the surface of the 47. The enunciator has a first contact 45 in electrical communication with and affixed by solder to the threaded surface of the 47. The enunciator has a second contact 43 in electrical communication with and affixed by solder to a bottom bulb contact 35a. The 43 has wire type insulation so as to be insulated from electrical communication with the threaded part of the 47 while also being affixed thereto. The bulb with integrated enunciator then goes through the steps described for the standard light bulb. A second aromatic material 49 is applied to the surface of an enunciator bulb with fragrance 47a. The 49 is then covered with an alternate cover or packaging 89 such that it does not interact with the environment such as being scratched off, or become moist, or oxidized. A packaged enunciator bulb 53 including enunciator bulb with aromatic 47b resulting from the preceding steps. once the bulb is to be utilized by a consumer, the packaging is removed to become a removed enunciator bulb packaging 55. Thus a process of making and using an aromatic light bulb with integral enunciator comprises a bulb manufacturing step, an enunciator integration step, an aromatic application step, a packaging step, a distribution/distribution step, and an un-packaging step.

Bulbs can be produced in large quantities very cheaply according to FIG. 1. The bulbs are cheap, the aromatic materials and steps to incorporate it with the bulb are cheap, and the enunciators can be made very small and cheaply—enunciators similar to those in FIGS. 14a and 14b have been use in inexpensive greeting cards for example. These bulbs can be used in a wide range of applications including marketing applicators such as those described herein.

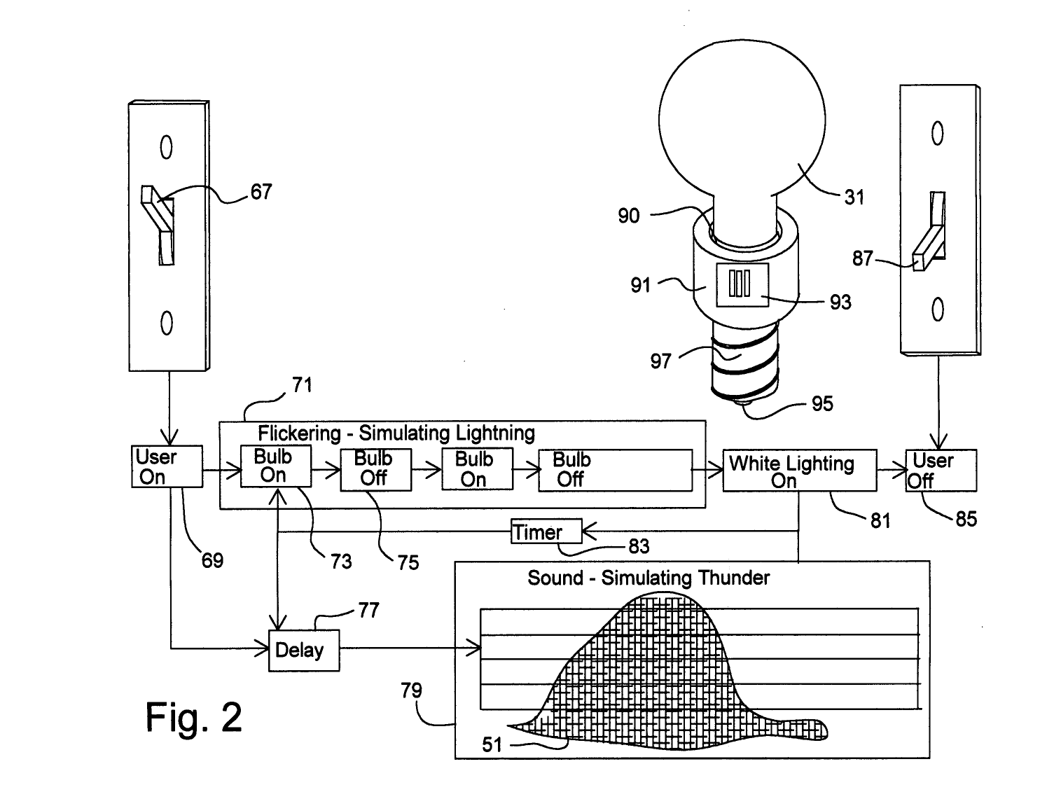

FIG. 2 illustrates the elements and operation process of a light bulb and a light fixture in a lightning/thunder embodiment. A user (not shown) turns “on” a wall switch 67 as a user “on” step 69. Plugged into a lightning enunciator fixture 91 controlled by the wall switch is a standard bulb with aromatic applied thereto of FIG. 1 which is screwed into an enunciator fixture socket 90 within the enunciator fixture. The 91 in-turn being screwed into a home light fixture (not shown) such that lightning fixture threads 97 and lightning contact 95 are in electrical communication with the home light fixture. The 91 comprising a capacitor (not shown but integrated into the 91) which causes the 31 to turn “off” and “on” repeatedly for a finite number of cycles lasting approximately 2 seconds in a flickering step 71. Concurrently with the capacitor cycles, a one step circuit (not shown but integrated into the 91) is counting to two seconds before it will turn “on” the light in a white light “on” step 81. Concurrently with the 71 step, a second one step circuit (not shown but integrated into the 91 and with the enunciator circuit in FIG. 14b) is causing a delay 77 for 1.5 seconds before triggering the enunciator circuit in FIG. 14b to make the sound of thunder 51 in a sound enunciation step 79. The enunciator circuit from FIG. 14b having been preprogrammed with the thunder sound stored in memory. After the completion of the flickering step, the white light will remain “on” until turned “off” during a user “off” step 85 where the user turns the wall switch to the “off” position 87. Thus after the user turns the switch “on” he experiences “lightning” when the light flashes “on” and off, “thunder” from the enunciator and then white light for normal illumination. A timer is also provided to enable the process to be automatically repeated according to a predetermined schedule with the timer circuit of 15a. An example of how this bulb can be used as a marketing tool is that the Coast to Coast AM radio show with Art Bell and George Noory periodically plays a thunder sound during their radio broadcasts and that specific thunder sound can be programmed into the enunciator circuit such that listeners will want the bulb and be reminded to listen to the show by the embedded sound and lightning flicker they experience each time they turn “on” the light in their home. Thus the light fixture with integral bulb comprises an “on” step, a timed light flickering communication step, a timed sound communication step, and an illumination of a user's environment step.

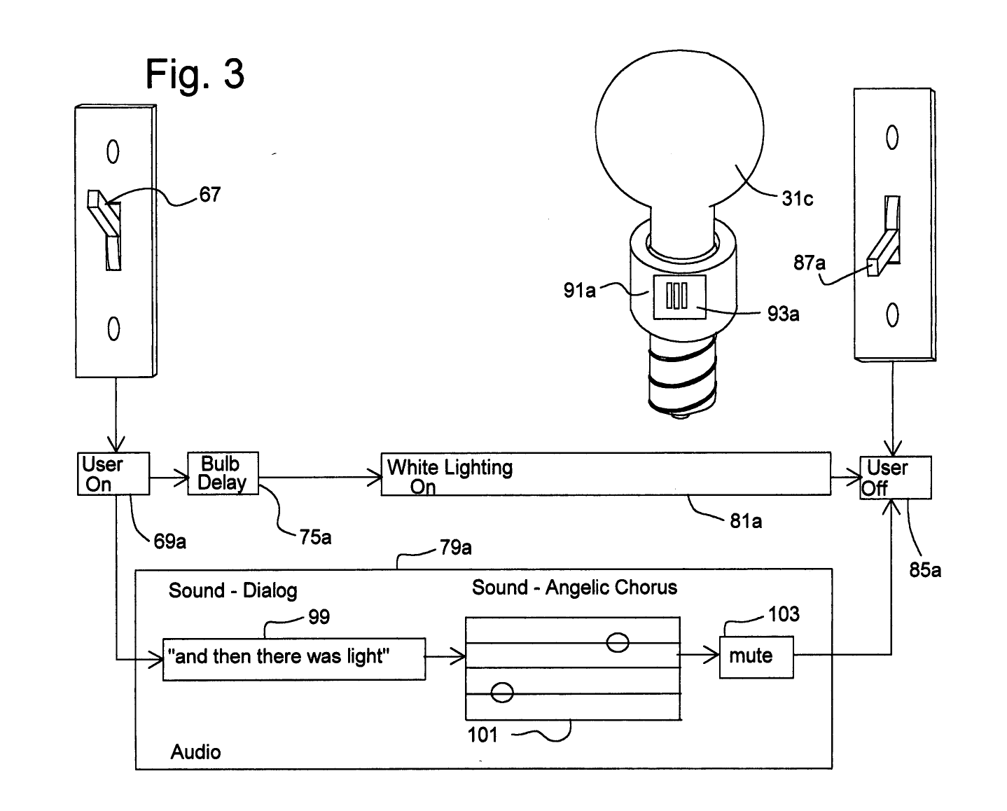

FIG. 3 illustrates the elements and operation process of a light bulb and a light fixture in an angelic embodiment. A second enunciator fixture 91a comprises a voice audio circuit containing a memory and an enunciator. Such circuits commonly can be preprogrammed with a sound including voice for playback “on” demand. The sound enunciator is integrated within the 91a to provide its sound from memory one time when it is first turned on. In a first angelic user step 69a, the users turns a second wall switch “on” 67a A third one step circuit (not shown but integrated with the second enunciator fixture 91a causes a two second delay 75a before turning “on” electricity to a fourth standard bulb 31c in a white lighting “on” step 81a. Meanwhile, as soon as the user completes 69a, a voice circuit (not shown) enunciates an “and then there was light” speech step 99 followed by an angelic choir for two seconds step 101, with the sound then becoming mute 103. The 99, 101, and 103 comprising an audible communication that was initiated with the switch being turned “on” by a user. In response to the user turning the light switch on, the start of the light was actually delayed which comprises a visual communications timed with the audible communication. The user turns the second wall switch 87a to the “off” position in a second user “off” step 85a. From a marketing stand point, religious people might like to have a light that reminds them of the Biblical account of Genesis which incorporates the timing of the light with an audible message while the 91a light fixture with bulb also fulfills the illumination function. Thus the light fixture with integral bulb comprises an “on” step, a timed sound communication step, a delayed light “on” step, and an illumination of a user's environment step.

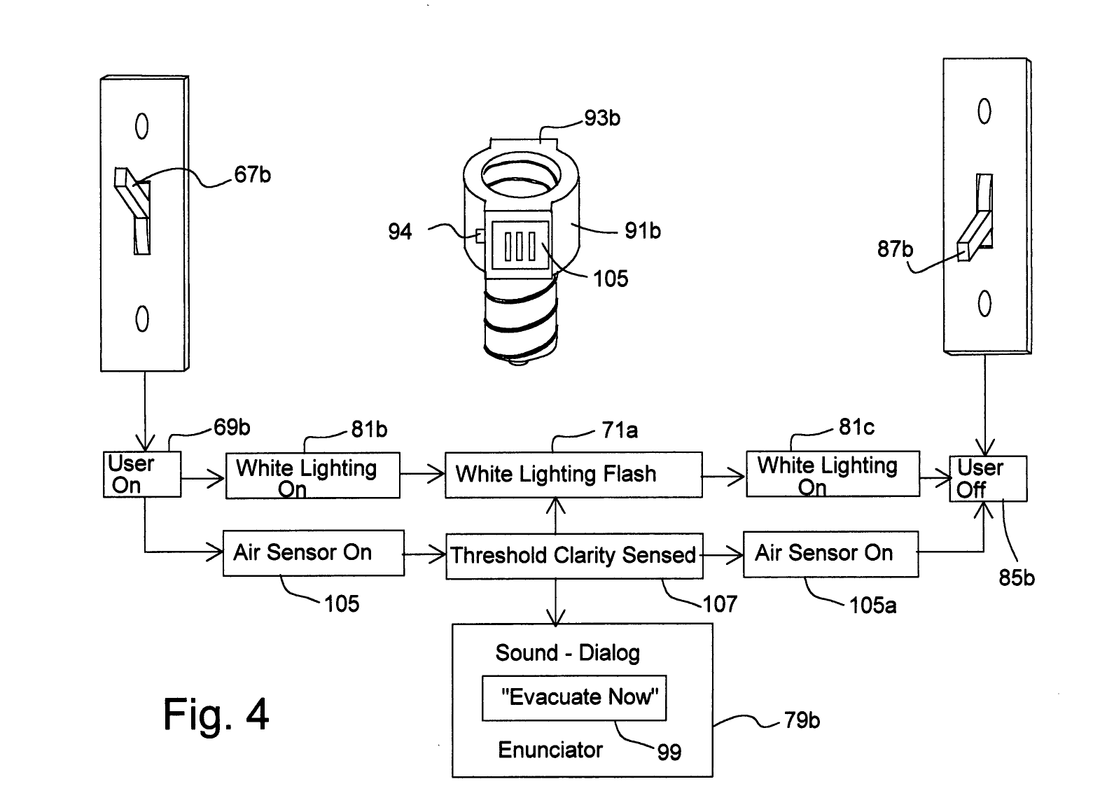

FIG. 4 illustrates the elements and operation process of a light bulb and a light fixture in an air clarity activation embodiment. A third enunciator light socket 91b comprises a third sound enunciator circuit 93b and an air clarity sensor 105 which is used to trigger the sound in memory within the 93b. Also, a user on/off switch 94 enables the user to turn the air clarity sensor and third enunciator circuit “off” or on. A user turns “on” a third wall switch “on” 97b in a user “on” step 69b. The switch “on” opens current flow to a bulb in the 91b (not shown) in a white light “on” step 81b and powers the air clarity sensor to perform an air sensing step 105. The air clarity senor circuits and hardware is common in smoke detectors for sensing smoke. In a threshold clarity sensed step 107, smoke or particulates have causes the air clarity to fall below a predetermined threshold and the sensor circuit triggers the circuit of FIG. 14b to enunciate an alarm sound step 79b including alarm 99. Also the power to the bulb (not shown is interrupted except through a capacitor that causes the light to turn “on” and “off”. Thus the 91b has triggered an audible and visual message in response to stimulus. When the clarity improves, the power to the bulb is restored 81c and the clarity sensor continues sensing 105a. In a third user “off” step 85b, a user can turn the fixture “off” using third wall switch “off” switch 87b. Thus the light fixture of FIG. 4 comprises an illumination of a user's space step, a concurrent air quality sensor step, a threshold air quality sensing step, a timed light communication step, and a timed sound communication step.

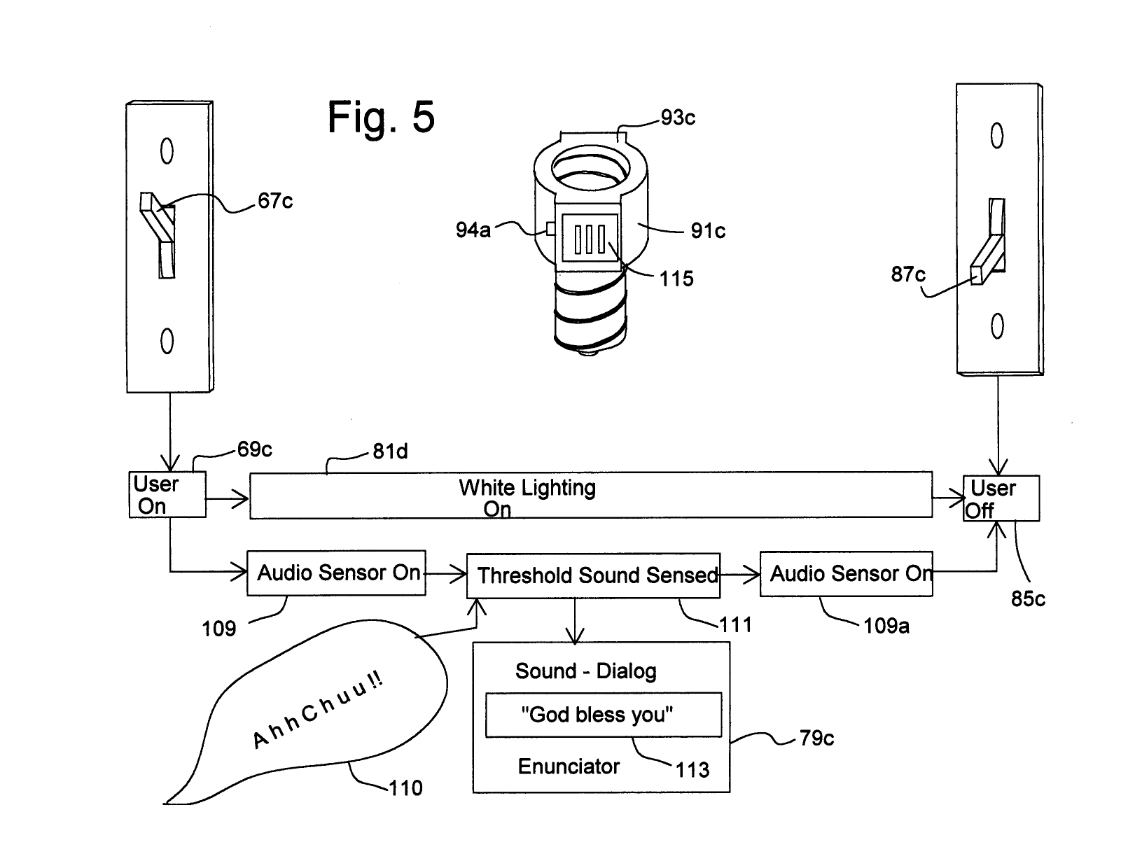

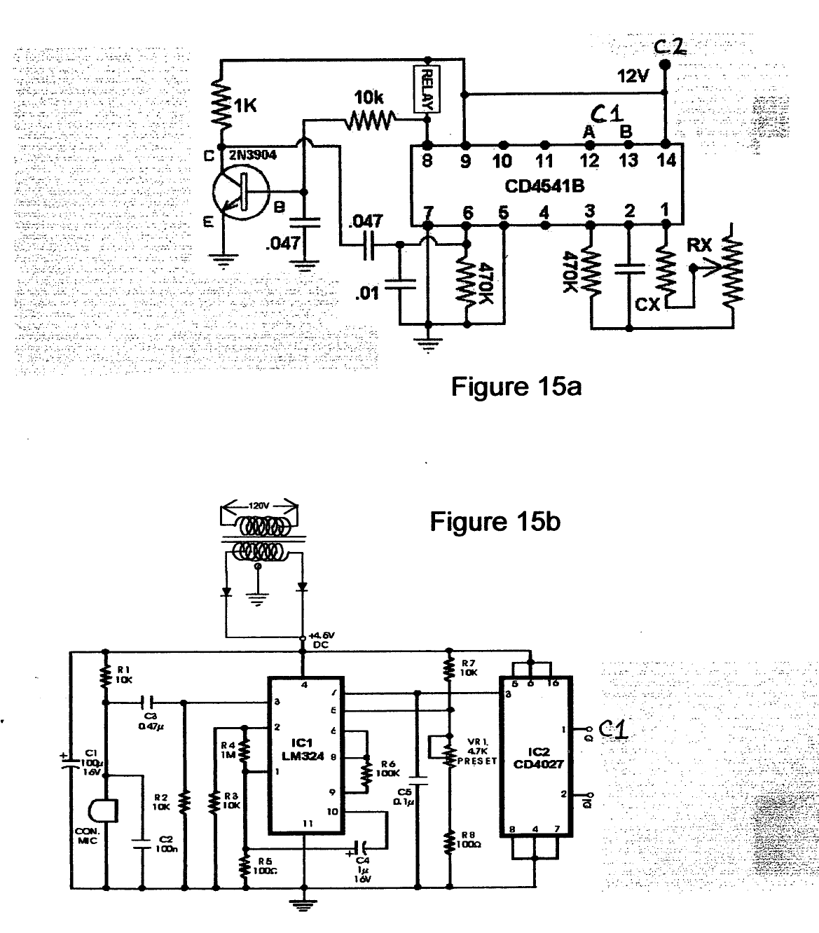

FIG. 5 illustrates the elements and operation process of a light bulb and a light fixture in a sneeze activated embodiment. A fourth “on” wall switch 67c is turned “on” by a user in a user “on” step 69c. Instantly, a light bulb (not shown) in a fourth sound sensing enunciator fixture 91c becomes illuminated in a white light “on” step 81d. Also instantly activated in an audio sensor “on” step 109 is a clapper sound sensor circuit 115 similar to that depicted in FIG. 15b. A user sneezing step 110, causes the 115 to sense a threshold sound 111. Upon sensing the sneeze, the FIG. 15b circuit triggers a fourth enunciator circuit 93c (which is similar to the circuit of FIG. 14b) such that a preprogrammed sound 79c is emitted in a god bless you step 113. In an audio sensor remaining “on” step 109a, the clapper sound sensor remains “on” to sense another sneeze 109a In a clapper fixture user “off” step 85c, the 91c fixture is turned “off” by a clapper wall switch in “off” position 87c. The 91c is also equipped with a clapper sound circuit disable switch 94a Thus a light fixture provided for the purpose of illumination of a user's environment doubles as a sound sensor that incorporates the means to enunciate a sound in response to a sound stimulus.

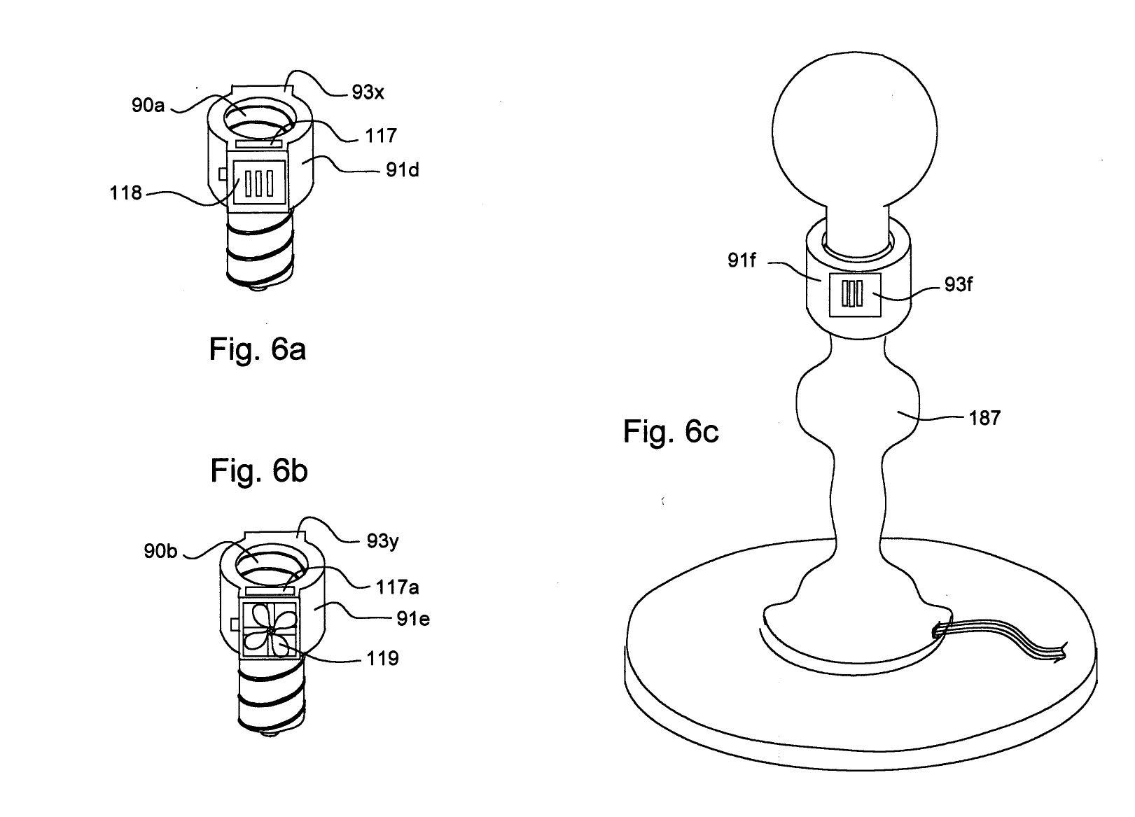

FIG. 6a illustrates the elements and operation process of a light bulb and a light fixture comprising an enunciator and an air freshener. A fifth enunciator circuit 93d is integrated into a fifth enunciator light fixture 91d integrated therein is a air freshener 117 and an air freshener aroma vent 118. A second bulb socket 90a receives a light bulb (not shown). The fixture is manufactured from plastic and the air freshener are passive elements that employ the heat of the operating incandescent light bulb (not shown) to dissipate the air freshener.

FIG. 6b illustrates the elements and operation process of a light bulb and a light fixture comprising an enunciator and an air fan. An air freshener enunciator circuit 93x is integrated into a sixth enunciator light fixture 91e integrated therein is a second air freshener 117a and an air freshener fan 119. The fixture is manufactured from plastic and the air freshener fans comprises an active aroma distribution element that moves air to dissipate the air freshener. The components for and processor of manufacturing the air freshener fixture with enunciator can be the same used for plug in air fresheners together with the sound enunciator circuits of either FIG. 14a or 14b. An application of the integrated enunciator air freshener is to notify a user when the air freshener is one means to achieve this is an electrical capacitance sensor integrated into a replaceable air freshener cartridge (not shown) that electrically connects to the 91d or the 91e. As the air freshener gets utilized, the capacitance is reduced. When the sense capacitance falls below a threshold, an audible sound is emitted or the bulb in a third socket 90b will flicker.

FIG. 6c illustrates the elements and operation process of a lamp comprising an enunciator. A lamp with enunciator 187 has a second air freshener enunciator 93y comprises a sixth enunciator fixture 91f. The circuit of FIG. 14a or 14b being integrated therein. This illustrates that the components described in the disclosure can be integrated into a light bulb or a light fixture or a wide range of other lighting hardware such as a lamp.

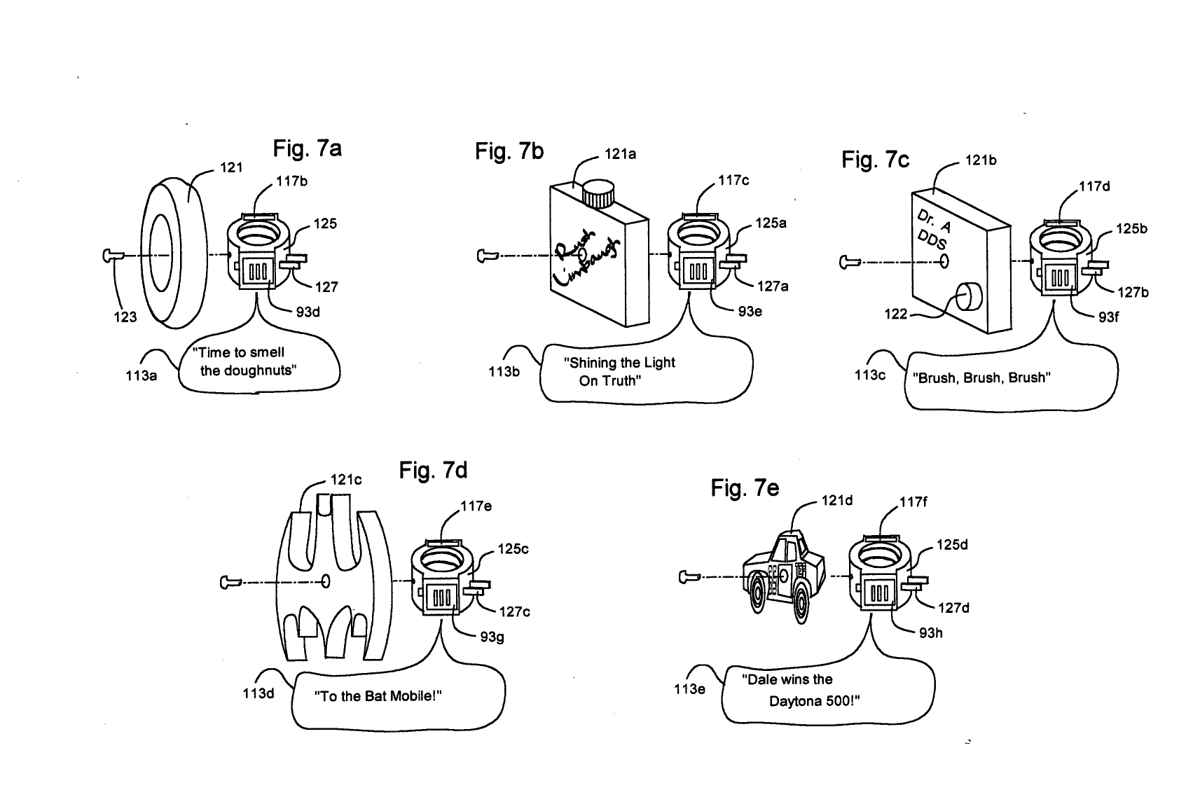

FIG. 7a illustrates the elements and operation process of a light fixture in a doughnut marketing jingle and smell embodiment. A screw 123 connects a plastic doughnut 121 to a plug in enunciator illumination socket 125. The 125 comprising a third air freshener 117b, a fifth enunciator circuit 93d such as that in FIG. 14a or 14b, and a plug in contact 127. In operation, the doughnut sound 113a is emitted when the 125 is turned “on” by a user for the purpose of illuminating his environment. The 113a comprising an audible marketing message relating to a product, the 117b comprising an aromatic message relating to the same product, the 121 comprising a visual product communication, and these three functions are integrated into an illumination fixture which performs the function of illuminating an environment. A product marketing company such as Dunkin Doughnuts may give away a variety of fragrance cartridges that smell like a variety different doughnuts as a marketing tool to keep their great products in a consumer's mind. Many products have similar appealing visual, audible jingles or sounds, and aromatic sensations that can similarly be delivered to the consumer each time he or she turns “on” a light. The selection provided herein being just a few examples.

FIG. 7b illustrates the elements and operation process of a light fixture in a radio talk show marketing jingle and smell embodiment. A plastic cologne bottle 121a is affixed to a second plug in illumination fixture 125a. The 125a comprising a fourth air freshener 117c, a sixth enunciator circuit 93e such as that in FIG. 14a or 14b, and a second plug in contact 127a. In operation, the radio talk show sound 113b is emitted when the 125a is turned “on” by a user for the purpose of illuminating his environment. The 113b comprising an audible marketing message relating to a Rush Limbaugh radio show, the 117c comprising an aromatic message smelling like a cologne being pitched “on” the radio show, the 121a comprising a visual product communication, and these three functions are integrated into an illumination fixture which performs the function of illuminating an environment.

FIG. 7c illustrates the elements and operation process of a light fixture in a dental office marketing jingle and smell embodiment. A plastic form with indicia including letters describing a dental office 121b is affixed to a third plug in illumination fixture 125b. The 125b comprising a fifth air freshener 117d, a seventh enunciator circuit 93f such as that in FIG. 14a or 14b, and a third plug in contact 127b. In operation, the dentist gives the fixture to his patient having small children, a brush your teeth sound 113c is emitted when the 125b is turned “on” by a user for the purpose of illuminating his environment. The 113c comprising an audible instructional message, the 117d comprising an aromatic message such as the scent of the dentists office, the 121b comprising a visual product communication including the dentists name and picture, and these three functions are integrated into an illumination fixture which performs the function of illuminating an environment. Also a motion sensor 122 provides the means to turn the Brush message on whenever someone such as a child walks into the bathroom for example. Thus providing a repetitive message to perform personal hygiene. The 122 being integrated with the enunciator circuit depicted in FIG. 14b.

FIG. 7d illustrates the elements and operation process of a light fixture in a motion picture marketing jingle and smell embodiment. A Batman plastic form 121c is affixed to a fourth plug in illumination fixture 125c. The 125c comprising a sixth air freshener 117e, an eighth enunciator circuit 93g such as that in FIG. 14a or 14b, and a fourth plug in contact 127c. In operation, a motion picture sound 113d is emitted when the 125c is turned “on” by a user for the purpose of illuminating his environment. The 113d comprising an audible merchandising message, the 117e comprising an aromatic message such as a smell that was referenced during the motion picture, the 121c comprising a visual product communication relating to the motion picture, and these three functions are integrated into an illumination fixture which performs the function of illuminating an environment.

FIG. 7e illustrates the elements and operation process of a light fixture in a sporting event marketing jingle and smell embodiment. A NASCAR plastic form 121d is affixed to a fifth plug in illumination fixture 125d. The 125d comprising a seventh air freshener 117f, an ninth enunciator circuit 93h such as that in FIG. 14a or 14b, and a fifth plug in contact 127d. In operation, a NASCAR sound 113e is emitted when the 125d is turned “on” by a user for the purpose of illuminating his environment. The 113e comprising an audible merchandising message such as the roar of a car or the sound of the announcer when Dale won, the 117f comprising an aromatic message such as a smell of the race track, the 121d comprising a visual product communication relating to the races, and these three functions are integrated into an illumination fixture which performs the function of illuminating an environment.

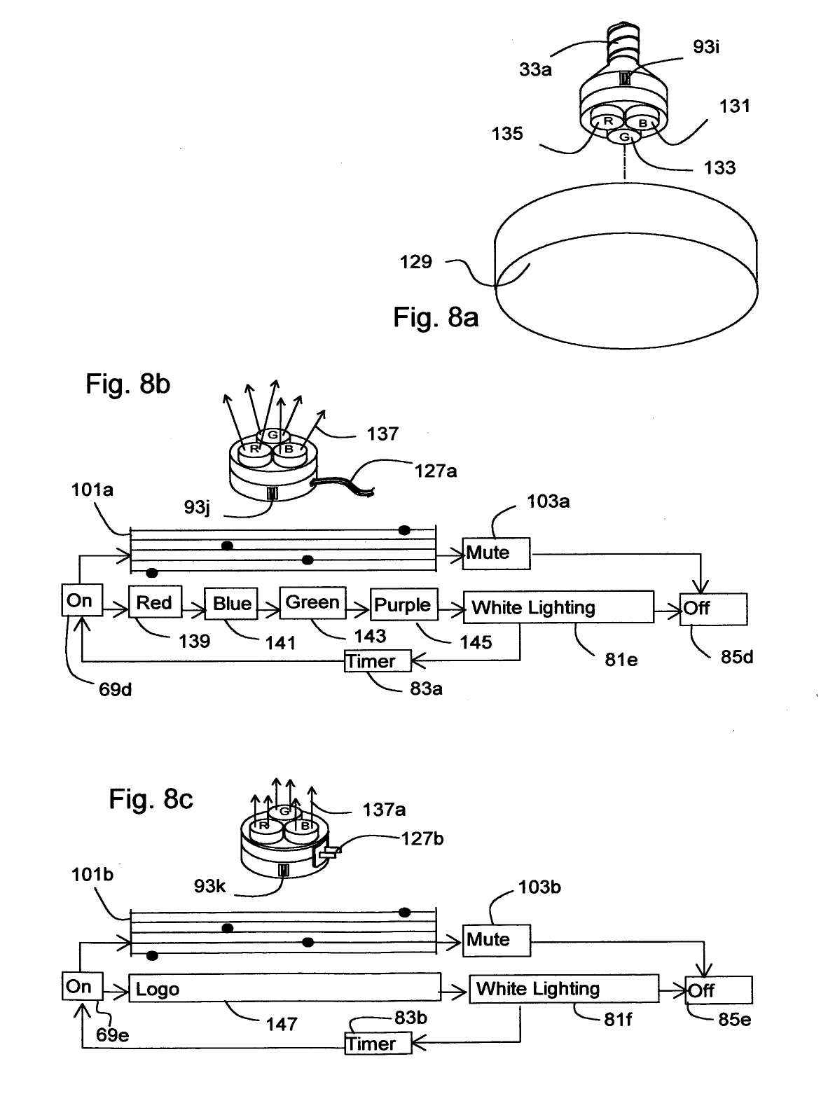

FIG. 8a illustrates the elements and operation process of an LED marketing/illumination light bulb with diffuser. An LED light bulb with enunciator comprises standard elements including semiconductors such as a red emitter 135, a green emitter 133 and a blue emitter 131 together with an LED bulb threading contact 33a Also integrated into the LED bulb is a tenth enunciator circuit such as that in FIG. 14a or 14b. A diffuser 129 can be used with the bulb in some applications. FIGS. 8b and 8c depict a similar bulb being used to produced a coordinated visual and audible message.

FIG. 8b illustrates the elements and operation process of an LED marketing/illumination light bulb with jingle and color flash pattern. In a fifth user “on” step 69d, a user turns an LED bulb with enunciator on. The bulb produces an Intel marketing jingle 101a that is a trademarked sequence of sounds that Intel commonly uses as part of its television and radio marketing strategy. Concurrently with the jingle is a sequence of light color flashes including a red flash 139, then a blue flash 141, and then a green flash 143, and then a purple flash 145. The red, green, and blue flashes can be produced using three capacitors each having a slightly different capacitance such that each LED color is initiated in a sequence. To produce the purple color, a fourth capacitor is connected from the power to both the red and blue semiconductors causing them to illuminate concurrently. Thus the sound sequence and the light flash sequence both play concurrently, respectively representing an audible marketing jingle and a visual marketing light flash sequence as part of an integrated marketing campaign. Once the marketing message is completed, a one step circuit causes all of the LED emitting elements to be power up such that white light is produced 81e to illuminate the user's environment meanwhile no further audio is produced during a mute phase 103a except that an LED enunciator bulb timer 83a comprising a timer circuit such as in FIG. 15a may cause the audio visual marketing message to replay at predetermined intervals. A user may turn the bulb “off” in a fifth bulb “off” step 85b. The LED bulb comprises a desk top fixture including a power cord 127a. An essentially dispersing light 137 is produced when a respective semiconductor is on. The bulb comprising an eleventh enunciator circuit 93j such as in FIG. 14a or 14b.

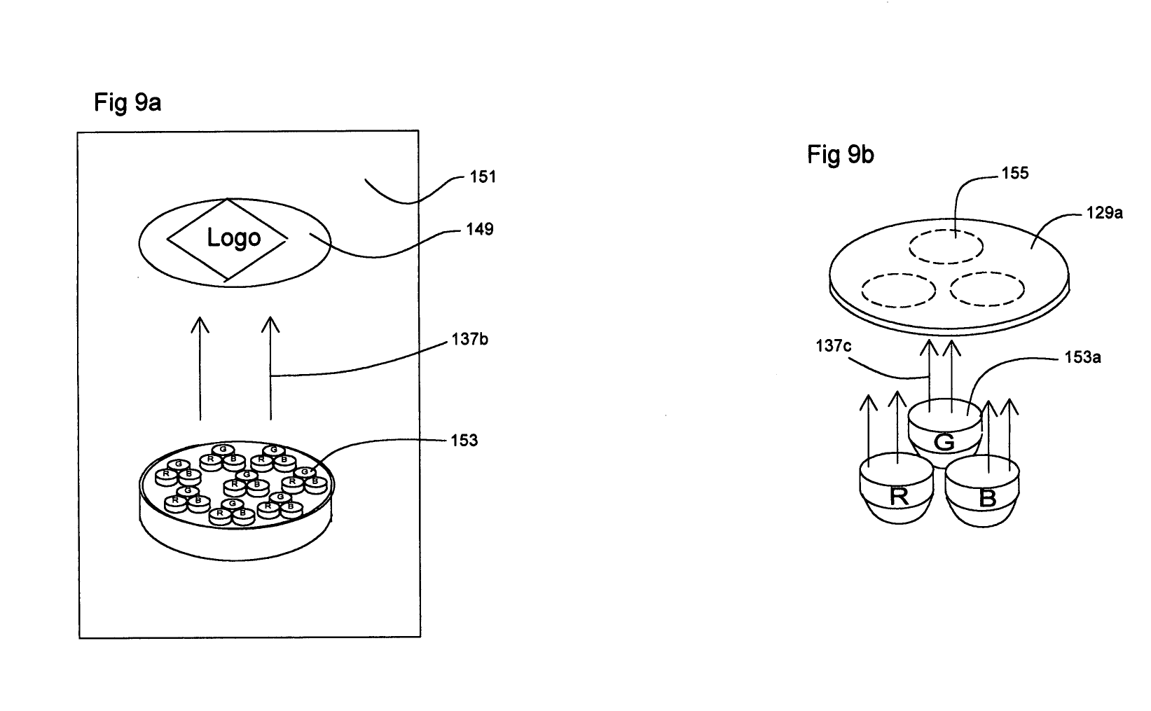

FIG. 8c illustrates the elements and operation process of an LED marketing/illumination light bulb with jingle and logo projection pattern In a sixth user “on” step 69e, a user turns an LED bulb with enunciator on. The bulb produces an Intel marketing jingle 101b that is a trademarked sequence of sounds that Intel commonly uses as part of its television and radio marketing strategy. Concurrently with the jingle is a projection of the Intel logo 147 which is further described in FIG. 9a. A third plug in contact 127b is provided as is a twelfth enunciator circuit 93k similar to that I FIG. 14a or 14b. Note that lenses are provided to produce an essentially collimated projection light 137a. Thus the sound sequence and the projected logo both play concurrently, respectively representing an audible marketing jingle and a visual marketing image as part of an integrated marketing campaign. Once the marketing message is completed, a one step circuit causes all of the LED emitting elements to be power up such that a seventh white light is produced 81f to illuminate the user's environment meanwhile no further audio is produced during a second mute phase 103b except that a second LED enunciator bulb timer 83b comprising a timer circuit such as in FIG. 15a may cause the audio visual marketing message to replay at predetermined intervals. A user may turn the bulb “off” in a sixth bulb “off” step 85e. The LED bulb comprises a plug in fixture including a power contact 127b. The bulb comprising an twelfth enunciator circuit 93k such as in FIG. 14a or 14b.

FIG. 9a illustrates the elements and operation process of an LED marketing/illumination light bulb projecting a logo projection pattern onto a wall. Smaller semiconductor segments such as small green semi conductor 153 enable the LED logo projection 149 to appear on a projection wall 151 using essentially non-dispersing light 137b produced using a predetermined optic (not shown) in a predetermined relationship with the 153 and similar semiconductors. To achieve the logo pattern, the semiconductors will be integrated with essentially two on circuits. A logo circuit will illuminate only the semiconductors required to project the logo and this circuit will be on when the logo is displayed. After the logo has displayed for a predetermined period a one step circuit will second white light circuit which essentially powers all of the semiconductors concurrently to produce white light for illuminating a user's environment.

FIG. 9b illustrates the elements and operation process of an LED marketing/illumination light bulb projecting a logo projection pattern onto a translucent diffuse surface. The semiconductor array of FIG. 9a can be used to project a logo onto a translucent diffuse surface 129a that is in close proximity to the semiconductors without the need for intervening optical components. The small green emitter 153a produces dispersing light that forms a green pixel 155 when the 129a is in close proximity thereto. During the white light mode, the diffuser will act as a normal light diffuser common among light fixtures as well.

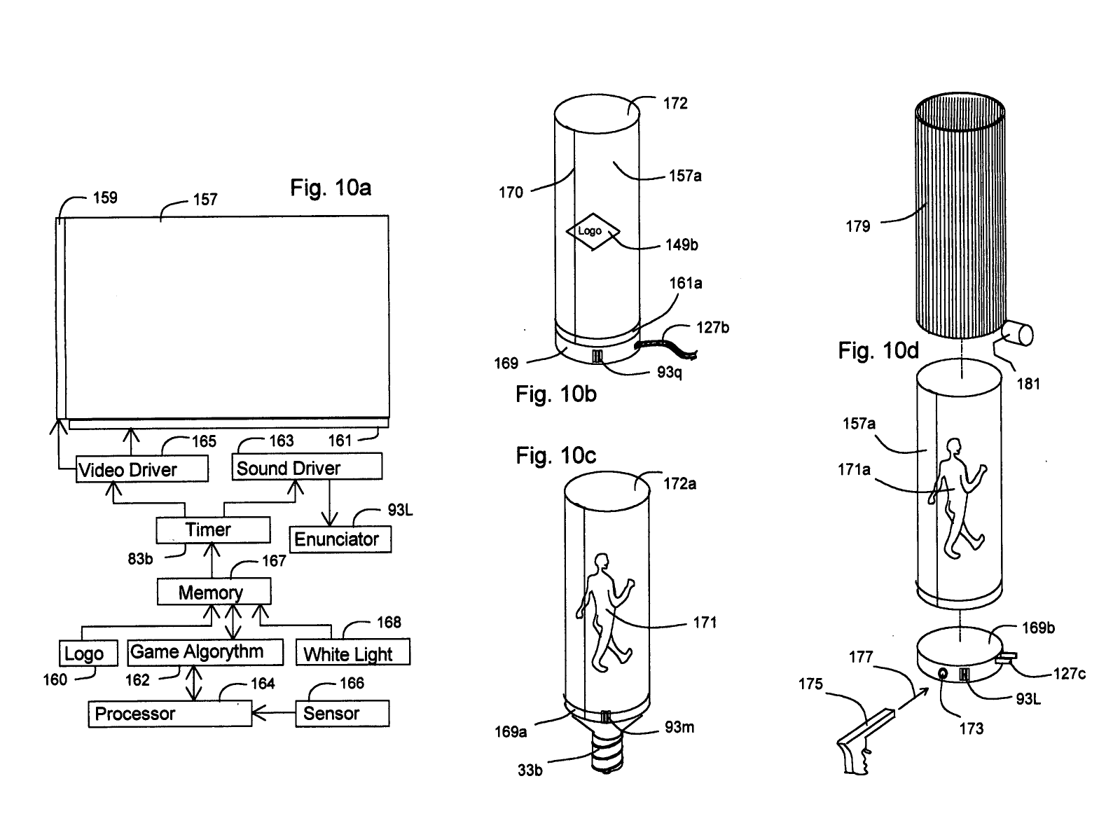

FIG. 10a illustrates the elements and operation process of a cylindrical OLED marketing/illumination light bulb. An flat flexible OLED array 157 is produced by well known means and is integrated with a horizontal conductor interface 159 and a vertical conductor interface 161. The interfaces providing the means to enable a video driver 165 to control the light emittance of an array of red, green, and blue organic diodes using active matrix or passive matrix control. A OLED/audio timer 83b is provided synchronize a marketing jingle with an OLED colored light flash sequence 162 similar to FIG. 8b or a OLED logo projection 160 similar to FIG. 8c. Note the 162 can be control color according to a game algorithm as well for interaction according to FIG. 10d for example. A white light map 168 comprises tuning all of the OLED diodes on concurrently so that the 157 can be utilized as a means to illuminate a user's environment. An OLED light memory 167 stores image maps, algorithms, and sound sequences which are driven by a sound driver 163 and enunciated by a thirteenth enunciator circuit. A processor 164 and an infrared light sensor 166 is provided as a means to enable user interactivity with the OLED illumination fixture as in FIG. 10d for example.

FIG. 10b illustrates the elements and operation process of an OLED marketing/illumination light bulb of FIG. 10a rolled into an OLED illumination desk top bulb. The OLED array of FIG. 10a has been curled into an OLED cylinder lamp 157a the joining seam 170 being where the two ends of the OLED array are glued together to form a continuous display enabling images such as the OLED Logo 149a to appear anywhere on the cylinder including over lapping the joining seam. The 157a is fitted to a desk top lamp format having a cylindrical base 169 and a cylindrical top 172 which supports the 157a to maintain the cylinder shape. The cylindrical shaped vertical contact interface 161a together with the 159 along with the components of FIG. 10a ensure images, and colored light flashes can be displayed in coordination with sounds and that white light illumination can be provide by this cylindrical OLED table top lamp with integral visual and audible marketing functions. A third power cord 127b provides power to the fixture and an eighteenth enunciator circuit 93q is provided.

FIG. 10c illustrates the elements and operation process of an OLED marketing/illumination light bulb of FIG. 10a rolled into an OLED illumination screw in bulb. A third OLED cylindrical bulb threads 33b enable the bulb to be screwed into any common light fixture. A second cylindrical base 196a and second cylindrical top 172a help the OLED cylindrical bulb to maintain its shape. When the bulb is turned on initially, it plays the Spiderman jingle which is prerecorded on the fourteenth enunciator circuit similar to that in FIG. 14a Concurrently with the Spiderman marketing jingle, the Spiderman character 171 moves around according to a predefined series of images in the 167 memory and according to FIG. 10a.

FIG. 10d illustrates the elements and operation process of an OLED marketing/illumination light bulb of FIG. 10a rolled into an OLED illumination 3D bulb with rotating lenticular array. A third OLED cylindrical bulb base 169b comprises a four plug contact 127c, a thirteenth enunciator circuit 93L and infrared sensor 173. The 173 enables a user to interact with the 157a for example using a toy gun 175 which emits an infrared light energy 177. The 173 in electronic communication with the 166 circuit of FIG. 10a. The mobile Spiderman 171a can be caused to move according to the user control of the 175. Also integrated with this OLED screw threads 33b are provided to enable the OLED cylindrical bulb to be screwed into any common light fixture. The bulb can display images such as Spiderman 171 and maintains its cylindrical shape integrity due to a top cylindrical support 172a and a bottom=cylindrical support 169a. A fourteenth enunciator 33b is provided. Also provided with the OLED cylindrical illumination bulb is a cylindrical lenticular array 179. The 179 is manufactured by creating a flat sheet of transparent flexible PVC and gluing it onto a rigid thin plastic cylinder. The 3D Spiderman image 171a on the OLED cylindrical light will actually consist of at least two sets of pixels to give the 3D sensation when viewed through the 179. Also to enhance resolution, it is possible to rotate the lenticular relative to the 157a using a motor 181.

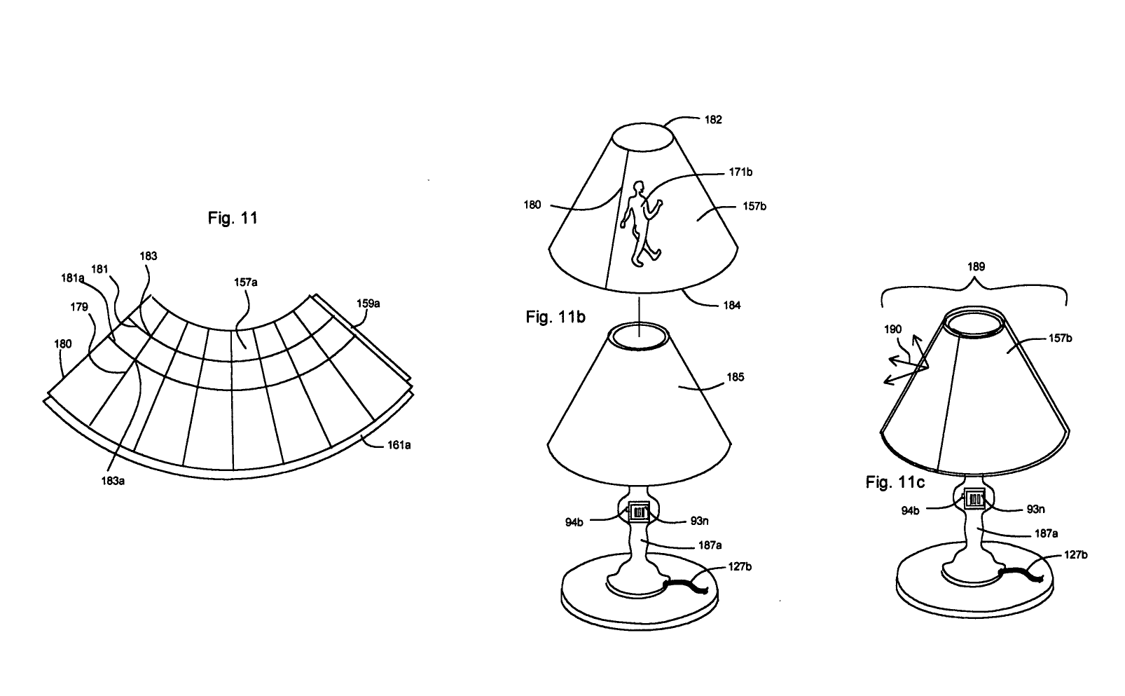

FIG. 11a illustrates the elements and operation process of a conic section OLED marketing/illumination light bulb. A flat OLED device is manufactured and integrated according to FIG. 10a except that the contact matrix for controlling the individual pixels is laid down in a concentric partial arc to form an OLED array suitable for conic section 157a. A first arc of contact deposition 181 is deposited on the first film that will encase the OLED and a second arc of contact deposition 181a is deposited on the first film that will encase the OLED. A first line of contact deposition 179 is deposited on the second film that will encase the OLED. The contact deposition process being one well known in the art of contact deposition for fabricating OLED displays. After the OLED encasement between the first film and the second film, the 179 controllably intersecting at a first OLED pixel 183 and a second OLED pixel 183a Many similar individually controllable pixels being similarly created by intersection of arc shaped contact depositions on the first film and line shaped contact depositions on the second film. The line shaped contacts being addressable by a vertical contact address interface 161a and a horizontal contact address interface 159a such interfacing known to the art for providing active matrix and passive matrix addressing possible with the only difference being that 161a is arc shaped.

FIG. 11b illustrates the elements and operation process of an assembled conic section OLED marketing/illumination light bulb and support form. The ends of the 157a are brought together to form a conic section OLED illumination display 157b having a conic seam 180 where the ends meet and are glued together. A conic Spiderman 171 image can be displayed according to FIG. 10a, 10b, and 10c. The conic section illumination/display surface comprising an OLED display with a cross section circumference that changes such that a first cross section circumference 182 is greater than a second cross section circumference 184. The 157b fitting onto a conic section form 185 that is made out of opaque plastic and provides support to ensure the shape of 157b is maintained. The 185 connected to a lamp shaped structure 187a which comprises a third power cord 127b, a fifteenth enunciator circuit and a lamp on/off switch 94b. Thus a fabrication process comprising contact deposition in the shape of arcs and lines and addressing in the shape of arcs and lines enables a lamp shaped OLED structure that can be used alternately for illumination or for displaying a logo, or flashing different colors in conjunction with a marketing jingle.

FIG. 11b illustrates the elements and operation process of an assembled conic section OLED marketing/illumination light bulb in the white light illumination mode. A conic section illumination lamp 189 emits dispersing white light 190 to illuminate a user's environment when all of the OLED pixels are powered on.

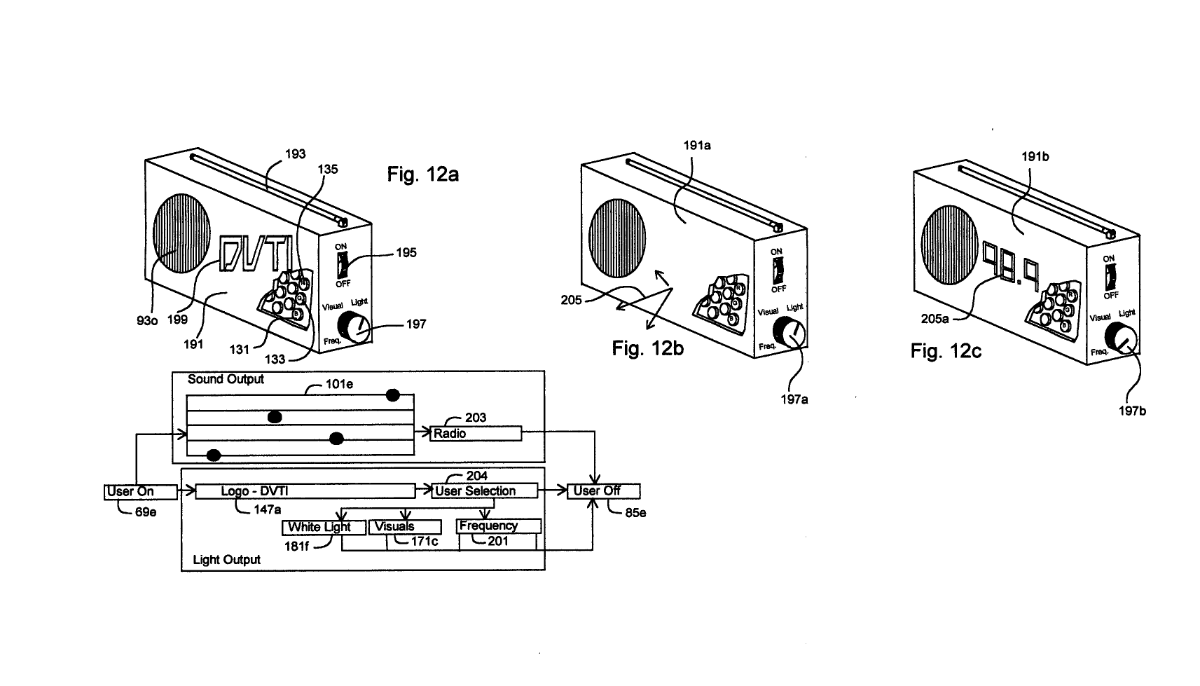

FIG. 12a illustrates the elements and operation process of a radio with integral illumination lamp and LED marketing communications system in the logo mode. OLED illumination radio in logo mode 191 comprises a translucent plastic casing material that contains the electronics of a radio including a large array of LEDs. When the radio is turned on, a company logo such as DVTI 199 is displayed as the radio plays a marketing jingle from its speaker 93c. The radio has an antenna 193, a red LED 135, a green LED 133, and a blue LED 131, and on switch 195, and a display mode selection switch. After a user switching radio on step 69e, the logo 147a is displayed concurrently with the audio jingle 101e. Once the logo and jingle are completed, the radio functions normally 203 and the user can select what will visually appear on the surface of the radio 204 from the LED lights. One choice is for the radio to function as an illumination lamp whereby all of the LEDs are lit to producing white 181f. The white light produced by the radio differs from radio flash lights in that the LEDs pass through the diffuse radio plastic case to produce a diffused generally non-directional light suitable for using as a room light for example. Alternate user controlled visual settings include a setting n where the LED light flash in a color sequence in response to the music play on the radio and a setting where the radio display data such as the frequency being played. The user can turn off the radio 85e. Thus the LED radio is an appliance that upon start up displays an audible marketing message concurrently with a visual marketing message and has an integrate illumination function to illuminate the environment for a user.

FIG. 12b illustrates the elements and operation process of a radio with integral illumination lamp of FIG. 12a in the illumination mode. A diffuse white light 205 is emitted from the LEDs through the translucent diffusing plastic casing of the radio in a white light mode 191a as controlled by a switch in light mode 197a.

FIG. 12c illustrates the elements and operation process of a radio with integral illumination lamp of FIG. 12a in the radio display mode. A frequency information light 205a is emitted from the LEDs through the translucent diffusing plastic casing of the radio in a frequency mode 191b as controlled by a switch in frequency light mode 197b.

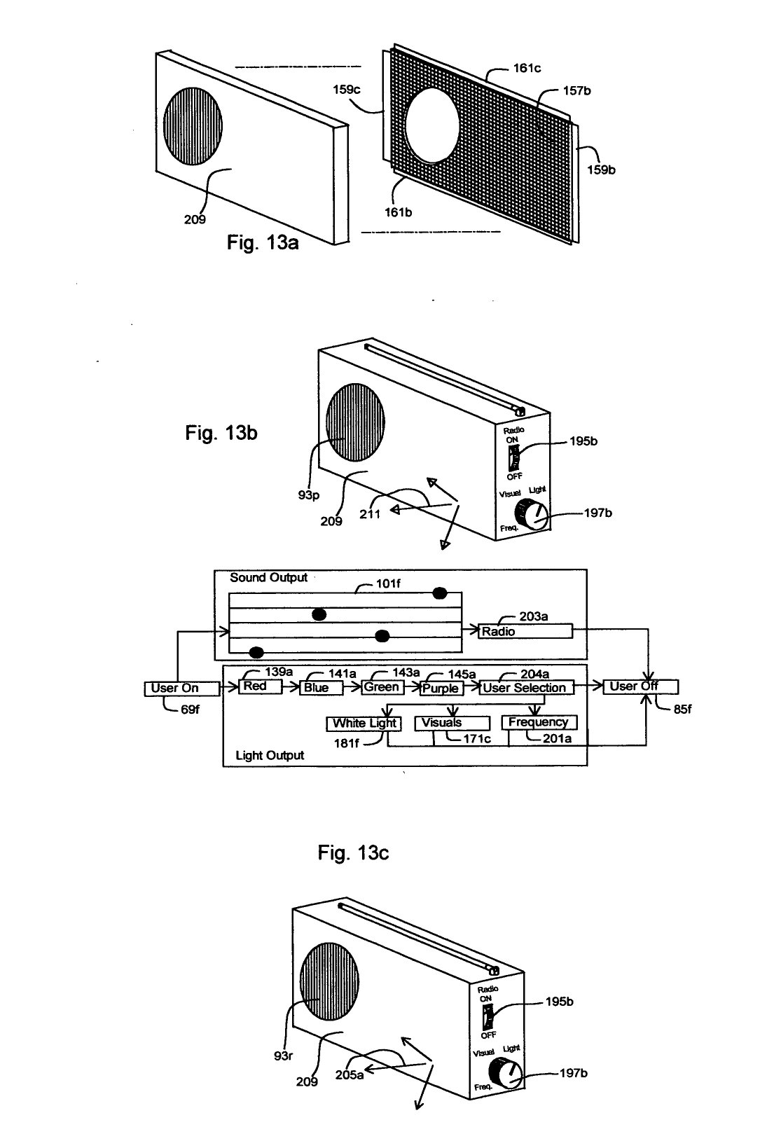

FIG. 13a illustrates the OLED element integrated into a radio with to perform integral illumination lamp and LED marketing communications. A transparent front radio casing 209 comprises a shape including a round area that allows air to pass through. A radio OLED display and illumination array 157b comprises a first horizontal addressing contact array 159c, a second horizontal addressing contact array 159b, a first vertical addressing contact array 161b, and a second vertical addressing contact array 161c. Whereas OLED arrays have heretofore only had a single horizontal contact array and a single vertical contact array, the advantage of the two presented here is that the entire 157b array can be controlled either as an active matrix or passive matrix array even though a circle has been cut out of the OLED array. Thus a greater percentage of the radio surface can provide illumination that would otherwise be possible. The 159c and 159b lines can be controlled in unison if they have been positioned to control the same lines of conductor depositions and corresponding OLED pixels or they can be controlled independently if they are positioned to control different rows of conductor depositions and corresponding OLED pixels. Similarly each of the corresponding 161c and 161b lines can be controlled in unison if they have been positioned to control the same lines of conductor depositions and corresponding OLED pixels or they can be controlled independently if they are positioned to control different rows of conductor depositions and corresponding OLED pixels. The conductor deposition process is the same as is known to the OLED manufacturing industry and the fabrication of the OLED lamination and encasement also that known to the industry. The improvement being that of an OLED array that can be controlled regardless of a hole in the middle of it.

FIG. 13b illustrates the elements and operation process of a radio with integral illumination lamp and LED marketing communications system in the marketing flash sequence mode. After a OLED radio user on step 69f, A OLED radio marketing jingle 101f plays from the OLED radio speaker playing jingle 93p and concurrently, the OLED array illuminates according to a pre-established marketing colored light flashing sequence such as a red OLED flash 139a, a blue OLED flash 141a, a green OLED flash 143a, and a purple OLED flash 145a comprising a concurrent flash of Red and blue. Thus the radio provides a coordinated marketing message including an audible message and a visual message. The user then controls what the display will display 204a including either a OLED radio white light 181f for environment illumination, other visual effects 171c, or frequency an other information 201a. The user may also turn off the OLED radio 85f. After the marketing jingle and light flashes conclude, the radio plays normally 203a. An OLED illumination radio flashes a red light 211 as part of a copyrighted color light flash sequence representing the visual component of a company's marketing campaign in conjunction with a copyrighted marketing jingle as the audible component the company's marketing campaign. An OLED radio switch in on position 195b can turn the radio on or off. When turned on, the radio performs the marketing jingle and lighting sequence. An OLED radio lamp visual control switch 197b.

FIG. 13c illustrates the elements and operation process of a radio with integral illumination lamp and LED marketing communications system in the illumination mode. After the light flash sequence and jingle o FIG. 13b are completed, the OLEDS are all switched to the on position to emit white OLED light 205a while the OLED radio speaker 93r plays the radio. Thus the OLED radio is an appliance that upon start up displays an audible marketing message concurrently with a visual marketing message and has an integrated illumination function to illuminate the environment for a user.

FIG. 14a illustrates an enunciator circuit suitable for integration with illumination products and emitting marketing jingles when activated.

FIG. 14b illustrates an enunciator circuit suitable for integration with illumination products and emitting marketing jingles and integration with timers and activating mechanisms.

FIG. 15a illustrates a timer circuit suitable for activating marketing jingles and concurrent coordinated lighting sequences.

FIG. 15a illustrates a sound sensor circuit suitable for activating marketing jingles and concurrent coordinated lighting sequences.

### OPERATION OF THE INVENTION

Operation of the invention has been discussed under the above heading and is not repeated here to avoid redundancy.

### CONCLUSION, RAMIFICATIONS, AND SCOPE

Thus the reader will see that the Integrated Illumination for Marketing Process and Apparatus of this invention provides an inexpensive, novel, unanticipated, highly functional and reliable means for communicating with consumers and enhancing their lives.

While the above description describes many specifications, these should not be construed as limitations on the scope of the invention, but rather as an exemplification of a preferred embodiment thereof. Many other variations are possible for example:

Many electrical circuits and enunciator systems are known that can be used to enhance the sound quality and range of the invention. Similarly, the invention can be integrated with additional triggering means to turn it on. Also the order in which visual, audible, and aromatic communication is delivered can be altered. Also the invention can be integrated with many other consumer products to make them essentially a lamp for illumination and a marketing communication medium For example, the invention can be incorporated into PCs and peripherals, kitchen appliances, automobiles, speakers and many other things.

What is claimed:

1. An illumination device for providing illumination to at least one person comprising:
at least one first element selected from the group consisting of, light bulb, electro-luminescent material, light fixture, and plurality of light emitters comprising elements of at least two distinguishable visible colors,
a predetermined illumination sequence comprising at least one characteristic from the group consisting of, a delayed “on”, at least one “on, off, on” sequence, a logo image, and at least two distinct colors emitted in a predetermined sequence,
an audio enunciator,
a predetermined sound sequence comprising at least one characteristic from the group consisting of, a delayed “on” before and audible sound, a sequence of at least two audible tones, and an audible voice message,
wherein in a predetermined sequence, the selected first element produces the selected illumination sequence and the audio enunciator produces the selected sound sequence and wherein the illumination and sound sequences comprise a predetermined message and wherein at a time selected from the group consisting of, before the message, during the message, and after the message, said first selected element produces light for the purpose of illumination.

2. A process for producing an aromatic light bulb article of manufacture comprising the steps of:
manufacturing a light bulb unit including,
providing electrical contacts,
providing an aromatic substance,
wherein the light bulb unit is manufactured to include the electrical contacts that will power its illumination during use and wherein the aromatic substance is affixed to the light bulb unit.

3. The process for producing an aromatic light bulb article of claim 1 further comprising the step of packaging the light bulb unit so as to insulate the aromatic bulb unit from environmental degradation of a type selected from the group consisting of; exposure to air, exposure to light, rubbing, scratching, heat, and moisture.

4. The process for producing an aromatic light bulb article of claim 3 further comprising the step of having the user remove the packaging prior to use of the aromatic light bulb.

5. The process for producing an aromatic light bulb article of claim 1 further comprising the step of providing a sound enunciator to be affixed to the bulb unit.
